(19) United States
(12) Patent Application Publication
(10) Pub. No.: US 2017/0286357 A1
(43) Pub. Date: Oct. 5, 2017

(54) Method, Apparatus And System For Communicating Between Multiple Protocols

(71) Applicant: Intel Corporation, Santa Clara, CA (US)

(72) Inventors: Satheesh Chellappan, Folsom, CA (US); Anoop Mukker, Folsom, CA (US); Bharat Daga, Bangalore (IN); David W. Vogel, Sacramento, CA (US)

(21) Appl. No.: 15/084,555

(22) Filed: Mar. 30, 2016

(51) Int. Cl. G06F 13/42; H04L 29/06

(52) U.S. Cl. CPC G06F 13/4291; H04L 69/08; G06F 13/4286

(57) ABSTRACT

In one embodiment, an apparatus comprises: a controller to communicate data having a format according to a first communication protocol, the controller comprising a Mobile Industry Processor Interface (MIPI)-compatible controller; an interface circuit coupled to the controller to receive the data, convert the data and communicate the converted data to a physical unit of a second communication protocol, the converted data having a format according to the second communication protocol; and the physical unit coupled to the interface circuit to receive and serialize the converted data and output the serialized converted data to a destination. Other embodiments are described and claimed.

### TECHNICAL FIELD

Embodiments relate to interfacing between different communication protocols in a computer system.

### BACKGROUND

Modern processors and systems on chip (SoC) are often formed of multiple different logic blocks, often referred to as intellectual property (IP) logics. Sometimes, IP logics of different communication protocols are incorporated into a single integrated circuit (IC). Oftentimes to enable communication between such IP logics within the integrated circuit and external devices, a physical unit (PHY), which is a hardware circuit to enable electrical communication to and from the IC in accordance with a given communication protocol, is provided. Thus when multiple different IP logics that communicate by different communication protocols are provided in an IC, similarly multiple physical unit circuits also are provided, which raise power consumption costs, real estate costs and so forth.

### BRIEF DESCRIPTION OF THE DRAWINGS

FIG. 1 is a block diagram of an interface circuit in accordance with an embodiment of the present invention.

FIG. 2 is a block diagram of further details of an interface circuit in accordance with an embodiment.

FIG. 3 is a flow diagram of a method in accordance with an embodiment of the present invention.

FIG. 4 is a flow diagram of a method in accordance with another embodiment of the present invention.

FIG. 5 is a block diagram of a portion of a system in accordance with an embodiment of the present invention.

### DETAILED DESCRIPTION

In various embodiments, interface circuitry may he provided within an IC to enable multiple communication protocols, such as multiple different serial-based communication protocols to communicate off-chip by way of a single common physical unit circuit (PHY). In this way, reduced real estate and power consumption can be realized.

Although the scope of the present invention is not limited in this regard, in an embodiment the common PHY may be a generic serializer/deserializer PHY, such as in accordance with a PHY Interface for the Peripheral Component interconnect Express (PCIe), referred to herein as “PIPE controller.” “PIPE” refers to hardware, software and/or firmware compatible with a PHY Interface for the PCI Express specification, such as the PHY Interface for the PCI Express, SATA and USB 3.1 Architectures Specification version 4.2 (published by Intel Corporation, 2013) or another version of such specification (hereafter PIPE specification).

And, while host controllers that act as interfaces between particular IP logics and the PHY may be PIPE-compliant, in certain designs one or more other host controllers may be of a non-PIPE-compliant communication protocol. More specifically in embodiments described herein one or more host controllers of a Mobile Industry Processor Interface (MIPI) M-PHY-based communication protocol may be present. Such MIPI-compliant host controllers may be in accordance with a given MIPI specification such as the MIPI Alliance Draft Specification for M-PHY (version 3.1 rev. 1, Nov. 2013).

While embodiments describe particular interface circuits, understand the scope of the present invention is not limited to these particular interface circuits. Instead, embodiments may be applied to a variety of different manners of interconnecting one or more host controllers of different communication protocols with a common PHY unit. This common PHY unit may be of one of the multiple communication protocols or can be instead of a different communication protocol.

More specifically, embodiments provide a mechanism to connect MIPI M-PHY-based hardware circuitry with an industry standard PIPE interface instead of connection with a physical layer through a MIPI M-PHY standard-defined Reference M-PHY Module Interface (RMMI). In this way, embodiments enable interconnection of a MIPI-compatible controller with a physical unit via a PIPE interface. As such a given set of links (e.g., transmit/receive (Tx/Rx) pairs) coupled to a chip can be configured for either M-PHY based or other serial communication protocols.

Using an embodiment of the present invention, a platform designer is afforded wide flexibility to configure a serial Tx/Rx pair for a MIPI protocol or another serial IO protocol. As examples, a SoC serial I/O hardware intellectual property (HIP) architecture may be configurable and use a single PIPE interface for all serial input/output (IO) controllers, such. as PCIe, Direct Media Interface (DMI), Serial Advanced Technology Attach (SATA), Gigabyte Ethernet (GbE) and Universal Serial Bus (USB) (and Universal Flash Storage (UPS) and Super Speed Inter Chip (SSIC) (which are exemplary M-PHY protocols)).

Embodiments may further reduce SoC cost so that a SoC does not have to dedicate Tx/Rx pins for a MIPI M-PHY-based protocol. Instead, a single set of pins can be configured for a non-MIPI M-PHY serial protocol if so desired for a platform configuration. This sharing allows package sharing of lanes between M-Pitt Y and other serial I/O protocols. Embodiments may Rather enable a M-PHY HIP and M-PHY controller to be designed based on the more popular PIPE interface than on an RMMI-based interface. By using an embodiment of the present invention, an interface circuit provides an interface that is fully compliant with a standard MIPI M-PHY protocol, with no deviation. As such, the conversion operations (and the included interface circuitry) described herein remain transparent to remote MIPI M-PHY device(s) to which a device is coupled.

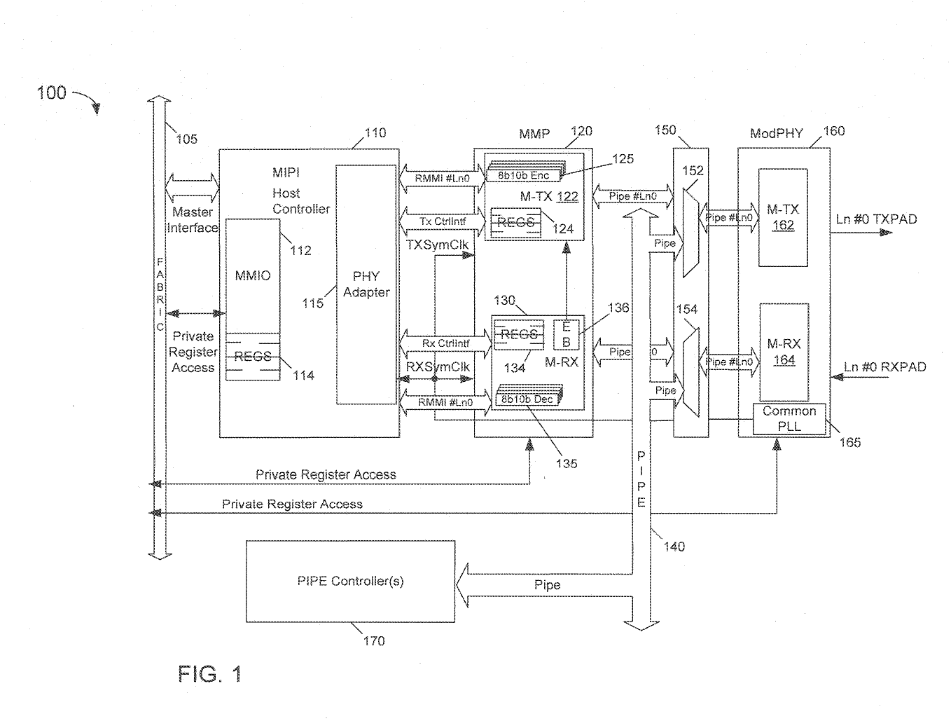

Referring now to FIG. 1, shown is a block diagram of an interface circuit in accordance with an embodiment of the present invention. As shown in FIG. 1, interface circuit 100 couples between a fabric 105, which may be a given interconnect fabric or other communication fabric of a semiconductor device, such as a processor, system on chip (SoC) or other such integrated circuit, and one or more sets of input/output pads of the device. These pads can couple, e.g., via a motherboard or other circuit board traces, to other components of a given computing system. In the particular implementation shown in FIG. 1, first lane data is transmitted as LN#0 TXPAD, e.g., via a pad of the device (or a pair of pads, in cases where a communication protocol provides for differential signaling).

Interface circuit 100 provides an interface between a MIPI-based host controller 110 and a physical unit circuit (PITY) 160 of another communication protocol. In various embodiments, PHY 160 may be any type of serializer/deserializer PHY, As such, the need for a dedicated MIPI-based PHY is avoided. Thus an interface circuit as in FIG. 1 provides a generic design that can be used in many different circuit implementations including MIPI-based circuitry and/or circuitry of other serial-based communication protocols. As examples, one or more other communication protocols may communicate in accordance with a PIPE specification.

As illustrated, a host controller 110 couples to fabric 105 via a master interface and a private register access channel. In turn, host controller 110, which as discussed above may be a MIPI-based controller, includes a PHY adapter 115. PHY adapter 115 receives information from fabric 105 and converts it into a RMMI-based communication. In different implementations, this RMMI-based Communication may be sent in parallel widths of 8, 16, 32, 64 or other bit widths. Host controller 110 further includes various storages, including a set of registers 114, which may store configuration information. Host controller 110 may further include a link layer, protocol layer, payload first in first out (FIFO) buffers and a direct memory access (DMA) engine to move data from/to memory. In addition, a set of memory mapped input/output (MMIO) registers 112 also are present. PHY adapter 115 further receives incoming RMMI-based communications and provides them, after conversion, to fabric 105 via the master interface. PHY adapter 115 may receive incoming USB packets and check for errors and strip off link and protocol headers. In turn, a data payload may be transferred to a memory location requested by a software driver.

As further illustrated, host controller 110 couples to a physical coding sub-layer (PCS) 120, more specifically referred to as a MIPI M-PHY PCS (herein “MMP”). MMP 120 provides an interface to convert RMMI-based communications to PIPE-based communications, and vice versa. In an embodiment, MMP 120 may be configured to perform the following operations: datapath translation between RMMI and PIPE (e.g., 8b/10b encoding (in transmit direction) and 8b/10b decoding (in receive direction)); RMMI configuration mode translation to various rate and gear speeds; support for low speed pulse width modification (PWM) transition between RMMI and PIPE using a divided clock; power mode translation of RMMI to PIPE; detection of decode/disparity error; elastic buffer support for handling parts per million (ppm) clock drift; inclusion of standard MIPI M-PHY registers (which cannot be implemented in a standard serial PHY, as its not MIN M-PHY aware); MIPI M-PHY-specific private registers, DFx and testability; and clock and power controls. MMP 120 can integrate with any MITI M-PHY protocol with a RMMI interface on its upstream side and on its downstream side integrate with a PIPE interface to a serial PHY that support MIPI gears and rate. The upstream can integrate with any M-PHY controller like UFS, Camera Serial Interface (CSI), SSIC, or Mobile-Express (Mobile PCIe (MEX)). Embodiments of MMP 120 can support single lane protocols or multi-lane protocols (like UFS, MEX and SSIG).

As further illustrated, MMP 120 includes a transmitter 122 including one or more encoders 125 and a set of registers 124, which provides storage of control/configuration information, useable both within transmitter 122 as well as to provide communication of such information to host controller 110. Thus as seen, RMMI data received in MMP 120 is encoded via one of a set of encoders 125 (which in an embodiment may be implemented as 8b/10b encoders) to thus encode the information into a PIPE-based format such that this data can be communicated via a PIPE-based protocol through a selection circuit 150 to a modular PHY 160.

In general, transmitter 122 takes RMMI byte information from host controller 110 and converts the information into a symbol interface. The transmit burst path (including PHY 160) involves an 8b/10b encoding and a parallel-to-serial conversion to translate the parallel. RMMI interface to a serial PIPE interface.

In general, receiver 130 converts a PIPE symbol interface to a controller RMMI interface. The receive datapath includes an elastic buffer 136 for clock compensation between a recovered clock and a receiver symbol clock at which receiver 130 operates. Receiver 130 may perform decoding of the symbol interface to byte format via decoder 135 and perform datawidth conversion from PIPE to RMMI, e.g., 8-bit PIPE to 32-bit RMMI.

MMP 120 further includes a RMMI configuration interface for updating standard M-PHY lane registers defined by a MITI M-PHY specification. To this end, this circuitry of MMP 120 may perform translation of MIPI M-PHY power saving states like SLEEP/STALL/HIBERN8 to PIPE power down states like P1/2/3, as shown in Table 1 below.

TABLE 1

| MIPI M-PHY | | |
|---|---|---|
| power saving | PIPE power | |
| states | down states | Comments |
| HS/PW BURST | P0 | Functional data transfer |
| | | mode |
| SLEEP | P1 | Idle mode between PWM bursts. |
| Weak STALL | P0 | Idle mode between HS bursts, |
| | | and used for shorter idle |
| | | residency. |
| Strong STALL | P1 | Idle mode between HS bursts, |
| | | and used for longer idle |
| | | residency. |
| HIBERN8 | P3 | Suspend mode, e.g., U3 for |
| | | SSIC protocol |
| DISABLE | P2 | Reset state, pipe_reset state |
| LINE_RESET | P0 | M-PHY line reset state is an |
| | | active state. Line reset will |
| | | be followed by pipe_reset state. |

Table 2 provides a description of MIPI M-PHY power states.

TABLE 2

| MIPI M-PHY | |
|---|---|
| power state | Description |
| HS BURST | High Speed active state for data transfer. This is one |
| | of the ACTIVATED state in M-TX and M-RX. |
| PWM BURST | Low Speed active state for data transfer in pulse width |
| | modulated bit format. This is one of the ACTIVATED |
| | state in M-TX and M-RX. |
| SLEEP | Power saving state used between PWM BURSTs. This |
| | is one of the ACTIVATED state in M-TX and M-RX. |
| STALL | Power saving state used between HS BURSTs. This is |
| | one of the ACTIVATED state in M-TX and M-RX. |
| | When the drive strength of DIF-N is strong in |
| | STALL, it's called Strong STALL state, compared |
| | to weak DIF-N for Weak STALL state. |
| HIBERN8 | Deepest low power state without loss of configuration |
| | information in M-TX and M-RX registers. |
| DISABLED | Its state of M-TX and M-RX when power may be valid, |
| | but the module is not enabled. |
| LINE-RESET | Reset via the LINE by means of the exceptional signal |
| | condition of a long DIF-P. |

Table 3 provides a description of PIPE power states.

TABLE 3

| PIPE | |
|---|---|
| Power | |
| State | Description |
| P0 | Normal operation state for PHY, Function state where data |
| | is transferred, or logical IDLE symbols are maintained. |
| P1 | Power saving state, low recovery time latency. PHY is |
| | required to maintain PCLK, some internal PHY clocks are |
| | gated. Controller will move the PHY to this state when both |
| | Tx and Rx are electrically idle. |
| P2 | Power saving state, longer recovery time latency. PHY is |
| | required to maintain PCLK, some internal PHY clocks are gated. |
| | This is the reset state of SERDES, which matches with |
| | DISABLE state of MIPI M-PHY. |
| P3 | Deep power saving state, longest recovery time latency. PHY |
| | can gate the PCLK and shutdown the PLL. |

As shown in FIG. 1, modular PHY 160 includes a transmitter 162 configured to receive this data and output it to a pair of two transmit pads, e.g., as a differential signal pair. Incoming communications are received and handled in the same, reversed manner. As further illustrated, PHY 160 includes a common phase lock loop (PLL) 165, which may be configured to receive an incoming control signal and output clock signals to transmitter 162 and receiver 164 as well as to the transmitters and receivers of MMP 120.

By providing a common PHY for both MIPI and non-MIPI protocols platform. configurability is enhanced by providing flexibility to choose Tx/Rx pin to MIPI M-PHY lane or non-MIPI lanes; silicon area improvements can be realized in part of, lane sharing as described herein SoC; and easy integration and validation by selection of single modular serial PERT for a SoC.

Selector circuit 150 in the embodiment shown includes multiplexers in the transmit and receive directions, namely multiplexer 152 in the transmit direction can be controlled to output a selected one of PIPE-based data from one or more PIPE controllers 170 or the PIPE-based data from MMP 120. And in the receive direction multiplexer 154 sends data to one of MMP 120 and PIPE controller(s) 170. To this end, a PIPE-based interconnect 140 provides interconnection between one or more PIPE controllers 170 and selector circuit 150.

Using an interface circuit such as MMP 120 enables a MIPI controller (such as host controller 110) to use a serializer/deserializer PHY. After conversion within MMP 110 of transmit MIPI-based data to PIPE-based data, the resulting data lanes may be dynamically multiplexed. While FIG. 1 shows lane multiplexers 152 and 154 of selector circuit 150 as separate blocks, in other embodiments such multiplexers can be implemented within MMP 120 or PHY 160.

Note that while 8b/1.0b encoding is performed in MMP 120 for MIPI-based data, for non-MIPI data such encoding can be done at its host controller (e.g., controller 170) or within PHY 160, depending on system configuration.

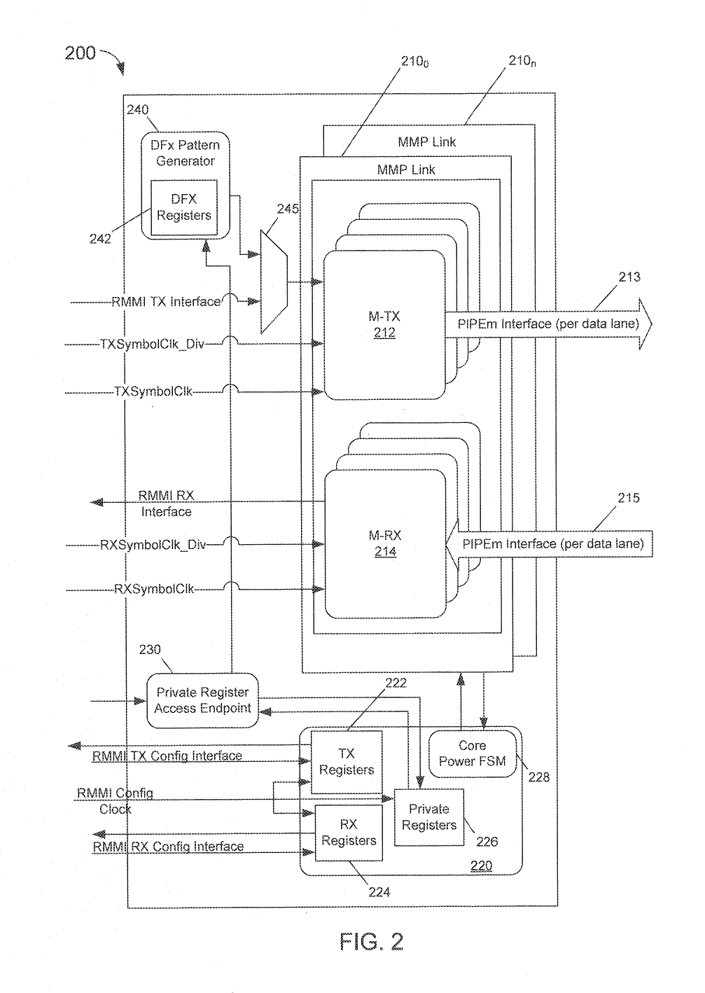

Understand while a single transmitter 122 and receiver 130 are shown within MMP 120 of FIG. 1 for ease of illustration, in a particular implementation MMP 120 may include multiple lanes of transmitters and receivers. More specifically, MMP 120 may include multiple transmitters 122 and receivers 130, each of which provides a PIPE interface for a given data lane. In addition, understand that the MMP itself may be implemented as a cluster including a plurality of separate MMP links, each of which may include multiple transmitters and receivers, along with other circuitry, as described further herein with regard to FIG. 2.

Referring now to FIG. 2, shown is a block diagram of further details of an interface circuit in accordance with an embodiment. More specifically, FIG. 2 shows further details of an MMP cluster 200 formed of a plurality of MMP links 210₀-210ₙ. As seen, each link 210 may include one or more transmitters 212 and receivers 214. Each transmitter 212 may be coupled to a PIPE interface 213, such that a given PIPE interface is provided for each transmitter 212. Similarly, each receiver 214 may be coupled to a PIPE interface 215, such that a given PIPE interface is provided for each receiver 214.

As further illustrated in FIG. 2, a control circuit 220 is present. Control circuit 220 may be configured to receive and transmit various configuration information, stored in a set of transmit registers 222 and a set of receive registers 224. In addition, a set of private registers 226 may be provided, which enable communication via a private interface with an upstream host controller (e.g., a MIPI host controller) through a private register access endpoint 230. Private register access endpoint 230 enables access to all standard and private M-PFIY registers. PWM mode low speed mode translation to a PIPE interface is supported. Note that a power and clocking architecture may be scalable and configurable to a number of lanes present in the SoC.

As further illustrated, control circuit 220 also includes a core power finite state machine (FSM) 228, which may be configured to control power states of the individual MMP links 210. More specifically, core power FSM 228 may he configured to place one or more of links 210 into a low power and/or clock gate state, e.g., based on traffic activity. Still further, core power FSM 228 may control the power states of links 210, e.g., based on power states of one or more cores of a processor or SoC. As such, core power FSM 228 maybe configured to place some or all of links 210 into a given low power state when some or all cores of the device also are in a low power state. Note that the low power states of these links may correspond to the low power states of the cores. Or in other embodiments, links 210 may be placed into low power link states that are different than corresponding low power states for the corresponding cores. Note that core power FSM 228 may implement per-lane power control such that unused lanes can be disabled. Core power FSM 228 may perform clock gating of various circuitry within an MMP cluster 220 to further reduce power consumption when opportunities exist. Understand while shown at this high level in the embodiment of FIG. 2, many variations and alternatives are possible.

In an embodiment, control circuit 220 may be implemented in a separate power domain than the rest of MMP cluster 200. As such, control circuit 220 may always he powered on by virtue of inclusion in an always-on power domain, while instead the remainder of MMP 220 may be implemented within one or more other domains, such as a power domain associated with one or more cores. As used herein, the term “domain” is used to mean a collection of hardware and/or logic that operates at the same voltage and frequency point. With this allocation of circuity to different domains, other portions of MMP 200 may be placed into a low power state, in certain circumstances. As further illustrated in FIG. 2, MMP 200 further includes a design for X (DFx) pattern generator 240, which may generate, e.g., test patterns responsive to configuration information stored in DFx registers 242. Then when in a given design or test mode, such test patterns may be provided via a multiplexer 245 to a given MMP link 210, instead of information received from an MIPI host controller.

As further shown, clocks are provided to operate MMP links 210, which in an embodiment may he received from a common PLL of the PHY. In an embodiment, such clocks may include a receiver symbol clock (RxSymbolClk) and a second clock signal, which may be a divided version of this clock signal (RxSymbolClkDiv) (in some cases a host controller may provide the divided version). In addition, a transmit symbol clock (TxSymbolClk) and another clock signal, which may be a divided version of this clock signal (TxSymbolClkDiv) are also received. In other cases, a host controller can provide all symbol clocks. These PLL/controller-supplied clocks may be used depending on mode of MIPI controller operation. More specifically, the RXSymbolClk/TXSymbolClk clock signals may be used during high speed operation (HS) while the divided clock signals may be used during a low speed (LS) mode.

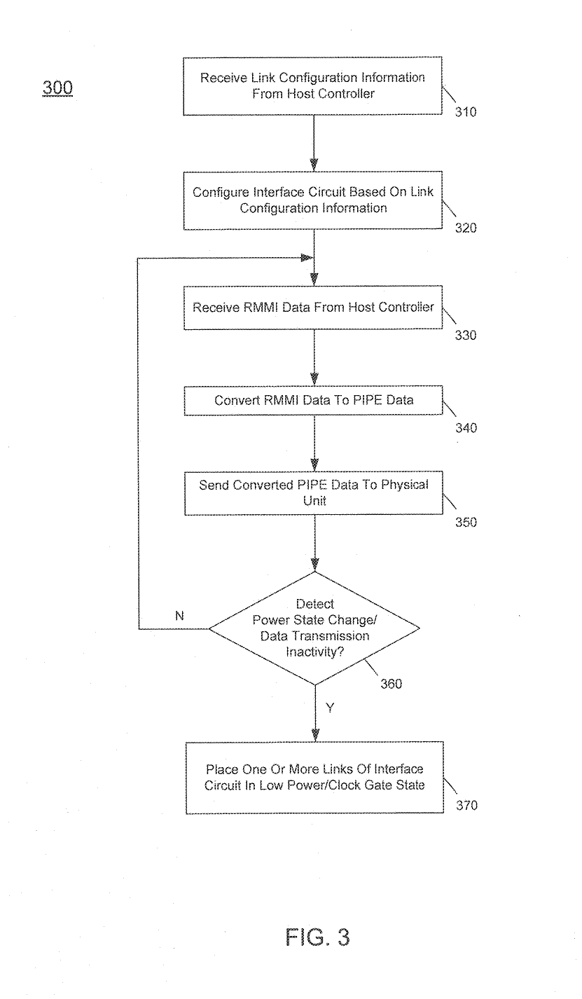

Referring now to FIG. 3, shown is a flow diagram of a method in accordance with an embodiment of the present invention. More specifically, method 300 shows operations that may be performed at least in part using a MMP or other interface circuit to provide interconnection between a host controller of one communication protocol and a PHY of another communication protocol. In the particular implementation of FIG. 3, as with the above Figures, assume that the host controller is a MIPI-compliant host controller and that the PRY is a PIPE-compliant PHY.

As illustrated in FIG. 3, method 300 begins by receiving link configuration information from a host controller (block 310). Various configuration parameter information may be communicated, including link widths, link speeds, among other information. Note that this link configuration information can be stored, e.g., in a configuration space of the MMP, such as within transmit and receive registers, via a RMMI configuration interface from a host controller, or a private register access endpoint of the MMP. The configuration of MIPI M-PRY standard lane registers is based on platform requirements, as provided for in a given MIPI M-PHY specification (such as described in version 3.1, rev. 01, section 8.4). Next at block 320 the interface circuit may be configured based on this link configuration information. As an example, different links of the MMP can be enabled or disabled based on a number of links to be active, and link speeds may be configured.

In an embodiment, platform register settings may be programmed by BIOS or other system software, to host controller 110. Then during MMP initialization, host controller 110 programs configuration registers within MMP 120 via the RMMI configuration interface. Although the scope of the present invention is not limited in this regard, in one example configuration registers (or fields thereof) may be provided for at least some of the following: Mode (PWM or HS); Gear (1/2/3 mainly setting the bandwidth); Rate (PLL reference series of A or B); Amplitude; SYNC/PREPARE parameters; etc.. In an embodiment, there may be two types of speed configuration: Gear 1/2/3 for 1.25 gigabit/per second (Gbps)/2.5G/5G data rates; and Rate A/B, where rate A speed may be at an indicated speed and Rate B speed is a predetermined data rate higher (e.g., 15%) than Rate A.

Still with reference to FIG. 3. at this point, it may be assumed that the MMP is configured for normal operation and data communications are to occur in this normal operation mode. Typically, once host controller 110 completes programming MMP 120, the new settings will be effectuated before data traffic starts. The management of most configuration parameters is done at boot/initialization time; however, some parameters can be managed dynamically during run time (but not during an active traffic state). In an embodiment, during boot/BIOS phase the Rate and Gears are fixed. As such, control passes to block 330, where the MMP may receive RMMI data from the host controller. Such incoming information may be received with a given bit width and provided to one or more transmitter circuits of the MMP. As discussed above, such transmitter circuits, may include driver circuitry and so forth, and encoding circuitry, such as sets of 8b/1.0b encoders. As such, at block 340, the MMP may convert the received RMMI data into PIPE data, namely encoded PIPE data. Still with reference to FIG. 3, next at block 350 this converted PIPE data may be sent to the PHY. Understand that in certain implementations, rather than a direct coupling of the MMP and the PHY, a selector circuit such as a multiplexer may be interposed between the MMP and the PHY to enable selected data to be provided to the PHY (namely data from the MIN, host controller or data from one or more PIPE controllers). On receipt of such PIPE data, the PHY may perform serialization operations to place the data into appropriate format, such as differential signal pair format (on a lane-by-lane basis) for communication via a given interconnect to which the SoC or other processor is coupled.

Still with reference to FIG. 3, power management activities can occur using the interface circuit to enable reduced power consumption in situations where other corresponding portions of the processor or SoC are in low power states. For example, runtime software may seek to manage or otherwise update a given parameter. First the register contents are set at host controller 110, which in turn programs MMP 120 when the transmitter and receiver are in SLEEP/STALL/Hibernate state. As shown in FIG. 3 at diamond 360 it can be determined whether a power state change has occurred. Such power state change determination may be based on information from the host controller. Or in some cases the MMP may receive information from one or more associated cores or other processing circuits of the processor or SoC that indicate entry into a given low power state. Still further at diamond 360, it can be determined whether data inactivity is detected. Understand that this data activity may be a cessation of data communications while in other embodiments, it can be based on determination that the data activity falls below one or more thresholds.

If based on the determination at diamond 360 a power state change has been detected and/or data transmission activity falls below a given threshold, control passes to block 370 where one or more links of the interface circuit (e.g., the MMP itself and/or other portions of the interface circuitry) can be placed into a given low power state. In some cases, rather than the latency and complexity involved in such low power state entry, clock gating may occur to given links or other portions of the MMP, such that reduced power consumption occurs with minimal overhead. If no detection of low power state/inactivity is identified, control instead passes back to block 330 (et seq.), for further data communication operations. Understand while shown at this high level in the embodiment of FIG. 3, many variations and alternatives are possible.

In an embodiment, clock gating may be performed during a Hibernate/Disable state, unless it instead is performed during a debug or bring up operation. Clock gating may typically be done at host controller 110, from where the divided symbol clocks are sourced. MMP 120 may be configured to send a clk_request signal and host controller 110 may respond with a clk_ack signal. During a Hibernate state, clk_request is deasserted and clocks are gated. When all lanes are in a LP state, main PLL 165 of PHY 160 is shutdown. In an aggressive power management mode, clock gating can be performed when there is no traffic during a SLEEP/STALL state.

In an embodiment, power gating may be performed only in a Hibernate/Disable state. In this state host controller 110 programs a Hibern8 register in MMP 120, which may maintain the runtime state synchronized between host controller 110 and MMP 120. When lane power gating is not enabled, power is gated only when all lanes are in the Hibern8 state. The power_req comes from MMP 120 and host controller 110 separately, the power_ack is returned by the PM unit in the SoC. In many implementations, the power rail supply for host controller and MMP are same.

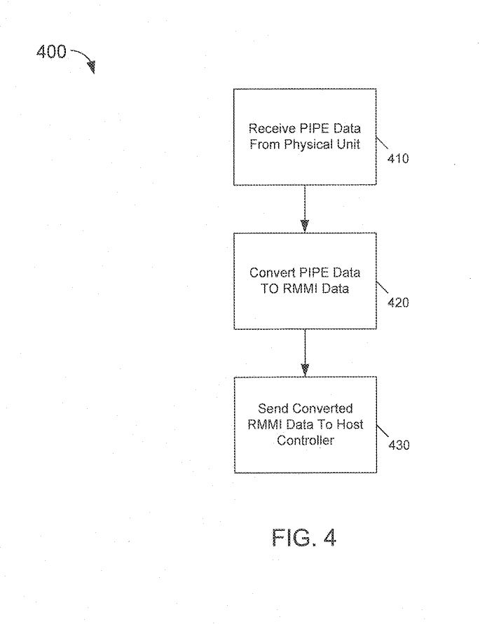

Referring now to FIG. 4, shown is a flow diagram of a method in accordance with an embodiment of the present invention. Method 400 of FIG. 4 may be performed in an interface circuit to receive incoming data, e.g., in a PIPE format, and condition it for output to a MIPI host controller. More specifically, this PIPE data may be received in an MMP or similar interface circuitry after receipt from a common PHY (block 410). Understand that this PHY may perform deserialization operations to place the data into appropriate format, such as parallel data of a given width, from an incoming differential signal pair format, after its receipt from an off-chip source. Next at block 420, the PIPE data may be 8b/10b decoded and driven to RMMI data. Then at block 430, this RMMI data is sent to the MIPI host controller (block 430). Understand while shown at this high level in FIG. 4, many variations and alternatives are possible.

Understand that interface circuits as described herein can be implemented into a variety of different ICs, including processors, SoCs and other such devices. In addition, via a common interface for multiple serial-based protocols, such. IC can couple to multiple other ICs via a serial interconnect.

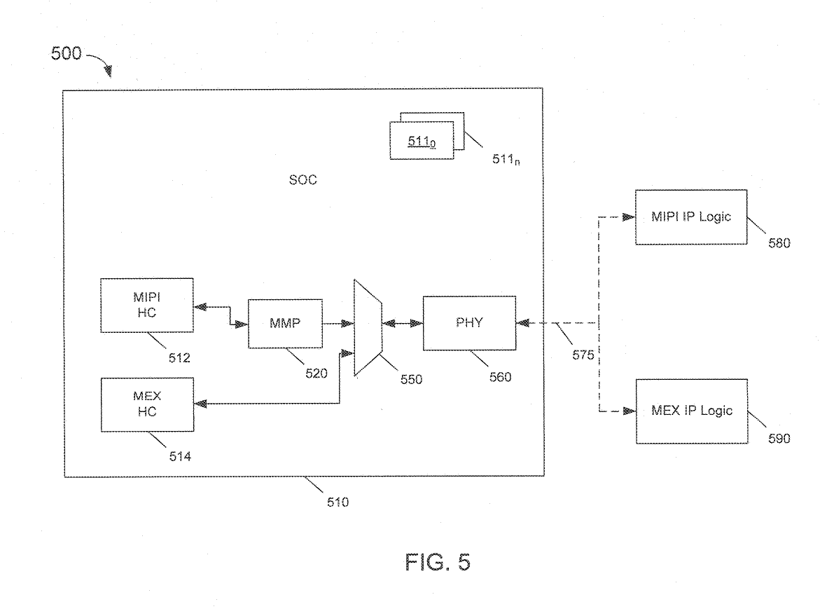

Referring now to FIG. 5, shown is a block diagram of a portion of a system in accordance with an embodiment of the present invention. As shown in FIG. 5, system 500 may be any type of computing device, ranging from small portable device such as smartphone or tablet to a larger device such as a desktop computer, server computer or so forth. As illustrated, a first IC 510 is an SoC that couples to other ICs via a serial connection 575. Note that this illustration of serial connection 575 is via point-to-point electrical connections to one IC at a time, rather than a multi-drop bus. In a given system, multiple serial connections may be provided, with a single IC communicating with the SoC at time, with other ICs electrically isolated. In the embodiment shown, IC 580 may include a MIPI IP logic, such as a camera logic or so forth. To this end, IC 580 may further include an M-PHY to receive and transmit serial data. IC 590 may be a Mobile-PCIe Express (MEX) IP logic, such as a given controller. In turn, IC 590 may further include a PRY (e.g., a M-PHY) to receive and transmit serial data. Note that in another embodiment, these disparate IP logics may be implemented within a single IC, In such case, this IC may include similar interface circuitry as described herein to enable a single common PHY to interact with both IP logics.

FIG. 5 further shows details of SoC 510. Specifically SoC 510 include a set of cores 511₀-511ₙ which may be homogeneous or heterogeneous cores, such as a mix of in order and out of order cores. SoC 510 farther includes multiple host controllers, namely a MIPI host controller 512 and a MEX host controller 514 (as examples). As seen, MIPI host controller 512 may interface with a MMP 520, which may be configured as described herein to provide interface circuitry to enable host controller 512 to communicate via a common PHY 560. To this end, a selection circuit 550 may be dynamically (or statically) controlled to enable communications between one or more of host controller 512 and 514 and PHY 560. As such, SoC 510 may include compatible interface circuitry such as shown in more detail in FIGS. 1 and 2. Understand while shown at this high level in the embodiment of FIG. 5, many variations and alternatives are possible.

The following Examples pertain to further embodiments.

In one example, an apparatus comprises: a controller to communicate data having a format according to a first communication protocol, the controller comprising a MITI-compatible controller; an interface circuit coupled to the controller to receive the data, convert the data and communicate the converted data to a physical unit of a second communication protocol, the converted data having a format according to the second communication protocol; and the physical unit coupled to the interface circuit to receive and serialize the converted data and output the serialized converted data to a destination.

In an example, the apparatus further comprises a selection circuit coupled between the interface circuit and the physical unit to selectively provide the converted data or second data received from a second controller to the physical unit, the second controller comprising a PIPE-compatible controller.

In an example, the interface circuit is to translate RMMI data to PIPE data.

In an example, the interface circuit comprises a plurality of link circuits, each including a transmitter and a receiver, each of the plurality of link circuits to communicate with the physical unit.

In an example, the interface circuit comprises a control circuit to control plurality of link circuits.

In an example, the control circuit comprises a power controller to independently control power states of the plurality of link circuits.

In an example, the control circuit comprises a translation circuit to translate first speed information of the first communication protocol received from the controller to second speed information of the second communication protocol, the control circuit to control a power state of one or more of the plurality of link circuits according to the second speed information.

In an example, the apparatus comprising a first integrated circuit and the destination comprises a second integrated circuit coupled to the first integrated circuit.

In an example, apparatus comprises an integrated circuit and the physical unit is a sole serial physical unit of the integrated circuit.

In an example, the physical unit comprises a common physical unit for the controller and a second controller, where the second controller comprises a non-MIPI-compatible controller.

In an example, the physical unit comprises a phase lock loop circuit to provide a first transmit clock signal and a first receive clock signal to the interface circuit.

In an example, the interface circuit is to convert the data to the converted data using the first transmit clock signal when the host controller is in operation at a first speed and convert the data to the converted data using a second transmit clock signal when the host controller is in operation at a second speed, the interface circuit to receive the second transmit clock signal from the host controller, the second clock signal comprising a divided version of the first transmit clock signal.

In another example, a method comprises: receiving, in an interface circuit, link configuration information from a host controller coupled to the interface circuit, the host controller comprising a MIPI-compatible controller; configuring one or more transmitters and one or more receivers of the interface circuit in response to the link configuration information; receiving first data from the host controller, the first data in a RMMI format; converting the first data to converted first data, the converted first data in a PIPE format; and sending the converted first data to a PHY unit, the PHY unit comprising a common PHY unit for the host controller and a second host controller, where the second host controller comprises a PIPE-compatible controller.

In an example, the method further comprises receiving first speed information from the host controller and translating the first speed information to second speed information, the second speed information PIPE-compatible.

In an example, the method further comprises receiving a divided clock signal from the host controller, and sending the converted first data to the PHY unit according to the divided clock signal, based on speed information of the link configuration information.

In an example, the method further comprises: placing the one or more transmitters and the one or more receivers into a first low power state, and thereafter receiving updated link configuration information; and updating one or more configuration parameters of the one or more transmitters and the one or more receivers based on the updated link configuration information, and thereafter causing the one or more transmitters and the one or more receivers to exit the low power state.

In an example, the method further comprises dynamically causing the converted first data or second data to be provided to the PHY unit, the second data received from the second host controller.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In another example, a system comprises a SoC and an IC coupled to the SoC. The SoC may include: at least one core; a controller to communicate data having a format according to a first communication protocol, the controller comprising a MIPI-compatible controller; an interface circuit coupled to the controller to receive the data, convert the data and communicate the converted data to a physical unit of a second communication protocol, the converted data having a format according to the second communication protocol; and the physical unit coupled to the interface circuit to receive and serialize the converted data and output the serialized converted data. In turn, the IC may include a MIPI WHY to receive and transform the serialized converted data to RMMI data.

In an example, the SoC further includes a second controller comprising a PIPE-compatible controller, and the physical unit is to receive and serialize second data from the second controller and output the serialized second data.

In an example, a second IC is to couple to the SoC, where the second IC includes a physical unit to receive the serialized second data.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMS) such as dynamic random, access memories (DRAMs), static random access memories (SRAMs), erasable programmable read-only memories (EPROMs), flash memories, electrically erasable programmable read-only memories (EEPROMs), magnetic or optical cards, or any other type of media suitable or storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a controller to communicate data having a format according to a first communication protocol, the controller comprising a Mobile Industry Processor Interface (MIPI)-compatible controller;
an interface circuit coupled to the controller to receive the data, convert the data and communicate the converted data to a physical unit of a second communication protocol, the converted data having a format according to the second communication protocol; and
the physical unit coupled to the interface circuit to receive and serialize the converted data and output the serialized converted data to a destination.

2. The apparatus of claim 1, further comprising a selection circuit coupled between the interface circuit and the physical unit to selectively provide the converted data or second data received from a second controller to the physical unit, the second controller comprising a PHY Interface for the PCI Express (PIPE)-compatible controller.

3. The apparatus of claim 2, wherein the interface circuit is to translate Reference M-PHY Module Interface (RMMI) data to PIPE data.

4. The apparatus of claim 3, wherein the interface circuit comprises a plurality of link circuits, each including a transmitter and a receiver, each of the plurality of link circuits to communicate with the physical unit.

5. The apparatus of claim 4, wherein the interface circuit comprises a control circuit to control the plurality of link circuits.

6. The apparatus of claim 5, wherein the control circuit comprises a power controller to independently control power states of the plurality of link circuits.

7. The apparatus of claim 5, wherein the control circuit comprises a translation circuit to translate first speed information of the first communication protocol received from the controller to second speed information of the second communication protocol, the control circuit to control a power state of one or more of the plurality of link circuits according to the second speed information.

8. The apparatus of claim 1, wherein the apparatus comprises a first integrated circuit and the destination comprises a second integrated circuit coupled to the first integrated circuit.

9. The apparatus of claim I, wherein the apparatus comprises an integrated circuit and the physical unit is a sole serial physical unit of the integrated circuit.

10. The apparatus of claim 1, wherein the physical unit comprises a common physical unit for the controller and a second controller, where the second controller comprises a non-MIPI-compatible controller.

11. The apparatus of claim 1, wherein the physical unit comprises a phase lock loop circuit to provide a first transmit clock signal and a first receive clock signal to the interface circuit.

12. The apparatus of claim 11, when the interface circuit is to convert the data to the converted data using the first transmit clock signal when the host controller is in operation at a first speed and convert the data to the converted data using a second transmit clock signal when the host controller is in operation at a second speed, the interface circuit to receive the second transmit clock signal from the host controller, the second clock signal comprising a divided version of the first transmit clock signal,

13. A computer readable medium comprising instructions that when executed enable a system to:
receive, in an interface circuit, link configuration information from a host controller coupled to the interface circuit, the host controller comprising a Mobile Industry Processor Interface (MIPI)-compatible controller;
configure one or more transmitters and one or more receivers of the interface circuit in response to the link configuration information;
receive first data from the host controller, the first data in a Reference M-PHY Module Interface (RMMI) format;
convert the first data to converted first data, the converted first data in a PHY Interface for the PCI Express (PIPE) format; and
send the converted first data to a PHY unit, the PHY unit comprising a common PHY unit for the host controller and a second host controller, wherein the second host controller comprises a PIPE-compatible controller.

14. The computer readable medium of claim 13, further comprising instructions that when executed enable the system to receive first speed information from the host controller and translate the first speed information to second speed information, the second speed information PIPE-compatible.

15. The computer readable medium of claim 13, further comprising instructions that when executed enable the system to receive a divided clock signal from the host controller, and send the converted first data to the PHY unit according to the divided clock signal, based on speed information of the link configuration information.

16. The computer readable medium of claim 13, further comprising instructions that when executed enable the system to:
place the one or more transmitters and the one or more receivers into a first topower state, and thereafter receive updated link configuration information; and
update one or more configuration parameters of the one or more transmitters and the one or more receivers based on the updated link configuration information, and thereafter cause the one or more transmitters and the one or more receivers to exit the low power state.

17. The computer readable medium of claim 13, further comprising instructions that when executed enable the system to dynamically cause the converted first data or second data to he provided to the PRY unit, the second data received from the second host controller.

18. A system comprising:
a system on chip (SoC) including:
at least one core;
a controller to communicate data having a format according to a first communication protocol, the controller comprising a Mobile Industry Processor Interface (MIPI)-compatible controller;
an interface circuit coupled to the controller to receive the data, convert the data and communicate the converted data to a physical unit of a second communication protocol, the converted data having a format according to the second communication protocol; and
the physical unit coupled to the interface circuit to receive and serialize the converted data and output the serialized converted data; and
an integrated circuit (IC) coupled to the SoC, wherein the IC includes a MIPI M-PHY to receive and transform the serialized converted data to Reference M-PHY Module Interface (RMMI) data.

19. The system of claim 18, wherein the SoC further includes a second controller comprising a interface for the PCI Express (PIPE)-compatible controller, and the physical unit is to receive and serialize second data from the second controller and output the serialized second data.

20. The system of claim 19, further comprising a second IC coupled to the SoC, wherein the second. IC includes a physical unit to receive the serialized second data.
